(19) United States
(12) Patent Application Publication
(10) Pub. No.: US 2009/0088022 A1
(43) Pub. Date: Apr. 2, 2009

(54) CONNECTOR

(75) Inventors: Dalibor KRIVOHLAVEK, Zagreb (HR); Goran Greguric, Zagreb (HR); Harald Michael Lutsch, Ottrau (DE)

Correspondence Address: SUGHRUE MION, PLLC, 2100 PENNSYLVANIA AVENUE, N.W., SUITE 800, WASHINGTON, DC, 20037, US

(73) Assignee: Yazaki Europe Ltd., Hertfordshire (GB)

(21) Appl. No.: 12/238,863

(22) Filed: Sep. 26, 2008

(30) Foreign Application Priority Data
Sep. 27, 2007 (DE) 102007046591.4-34

(51) Int. Cl. H01R 13/40

(52) U.S. Cl. 439/595

(57) ABSTRACT

Connector 1 for connecting to a mating connector 2, comprising a housing 3, which has a first housing portion 4 with accommodation chambers 13 for contact elements 19 and a second housing portion 5 with a receptacle for a housing portion of the mating connector 2, at least one secondary locking element 9, which is mounted pivotably on the housing 3 between an unlocking position and a locking position, which has a locking portion 10, which projects in the locking position of the secondary locking element 9 at least into one accommodation chamber 13, and which has a blocking portion 11, which, in the unlocking position, prevents a complete connection of the mating connector 2 to the connector 1 and which, in the locking position of the secondary locking element 9, enables a complete connection.

The invention relates to a connector for connecting to a mating connector, wherein the connector has a receptacle for a housing portion of the mating connector and comprises a secondary locking element, which prevents in an unlocking position a connection of the mating connector to the connector.

Such a connector is known from DE 10 2004 026 665 A1. The connector comprises a slider, which is displaceably guided transverse to a longitudinal axis on a housing of the connector. The slider has a retaining element, which projects beyond an end face of the connector. In a first position, in which the slider does not lock the contact elements, which are held in accommodation chambers of the connector, the retaining portion is arranged such, that, during a try to connect the mating connector to the connector, the mating connector abuts the retaining portion, so that a connection is prevented. In a second position the retaining portion is pushed into a position, in which a connection is enabled, as the mating connector does not abut the retaining portion.

From EP 1 073 153 A2 a connector for female contact elements is known, wherein on the housing of the connector, secondary locking elements are formed, which are pivotable by means of a film hinge. The secondary locking elements project beyond an outer face of the connector, when they are in an unlocking position. In this position, the connector can not be inserted into a receptacle of a mating connector, as the secondary locking elements abut an end face of a receptacle wall. When the secondary locking elements are transferred into a locking position, these are flush with an outer face of the connector, so that the connector can be inserted into the receptacle of the mating connector.

The object of the present invention is to provide a connector with a receptacle for a mating connector, which has at least one secondary locking element, which prevents in an unlocking position a connection of the mating connector to the connector.

The object is solved according to the invention by a connector, for connecting to a mating connector, comprising a housing, which has a first housing portion with accommodation chambers for contact elements and a second housing portion with a receptacle for a housing portion of the mating connector, at least one secondary locking element, which is mounted pivotably on the housing between an unlocking position and a locking position, which has a locking portion, which projects in the locking position of the secondary locking element at least into one accommodation chamber, and which has a blocking portion, which, in the unlocking position, prevents a complete connection of the mating connector to the connector and which, in the locking position of the secondary locking element, enables a complete connection.

Thus, a solution is provided, which also ensures in case of a secondary locking element, provided pivotably on a housing of the connector, that in the unlocking position, a connection of the mating connector to the connector is prevented. A slider is not necessary.

In this case, the blocking portion is arranged such, that the mating connector abuts, when connecting to the connector, with an end face the blocking portion to prevent a connection of the mating connector to the connector.

The secondary locking element, in the form of a rocker, is mounted pivotably between the locking portion and the blocking portion on the housing. Thus, the blocking portion is moved in opposite direction to the locking portion, when transferring the secondary locking element from the unlocking position into the locking position. Preferably, in this case, the secondary locking element is integrally and pivotably connected via a film hinge to the housing. Thus, the manufacture is especially simple and the assembly of a separate component not necessary.

The blocking portion is preferably arranged such, that this projects in the unlocking position of the secondary locking element into the receptacle of the housing. Thus, a simple possibility is given, to arrange the blocking portion in the unlocking position there, where the mating connector has to be inserted. Thus, it is ensured, that the mating connector abuts with a housing portion on the blocking portion, if someone tries to connect this to the connector.

Preferably, in the locking position of the secondary locking element, the blocking portion is arranged outside of the receptacle of the housing. Thus, the receptacle is free of obstacles, so that the mating connector can be inserted into the receptacle. Another possibility could be, that the blocking portion abuts on an inner wall of the receptacle and, when connecting the mating connector to the connector, is accommodated in a recess of the mating connector. Thus, the blocking portion would still be present in the receptacle, however, it would not abut on a face of the mating connector. The first housing portion of the connector has an end face limiting the receptacle, beyond which the blocking portion projects.

In the first housing portion of the housing, the accommodation chambers are arranged parallel to a longitudinal axis.

The contact elements are insertable, starting from a rear side of the housing, respectively into an accommodation chamber. In this case, the contact elements can project in a completely inserted final position with a contact portion from the housing portion into the receptacle. In this case, they project beyond the end face.

Preferably it is provided, that the locking portion of the at least one secondary locking element has at least one locking projection, which, in the locking position, projects into at least one of the accommodation chambers and engages behind a locking face of a completely inserted contact element, to prevent a pulling out of the contact element, wherein the locking projection, in a case of one not completely inserted contact element, when transferring the secondary locking element from the unlocking position in the direction of the locking position, abuts on a holding portion of the contact element and prevents a transferring of the secondary locking element into the locking position.

In the following a preferred embodiment is described in detail by means of the drawings. It shows

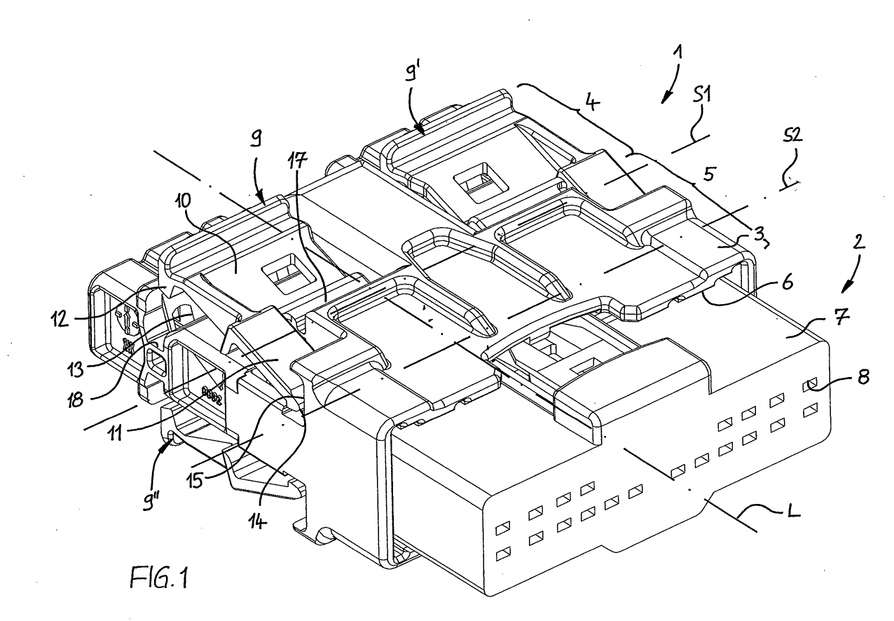

FIG. 1 a perspective representation of a connector according to the invention with a mating connector, wherein secondary locking elements are in an unlocking position,

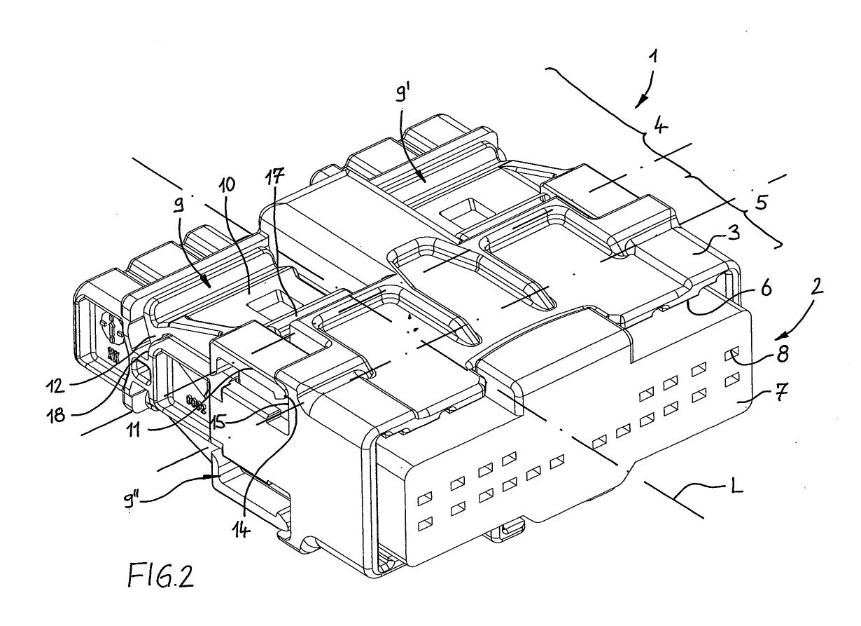

FIG. 2 a perspective representation of a connector according to the invention and of the mating connector of FIG. 1, wherein the secondary locking elements are in a locking position,

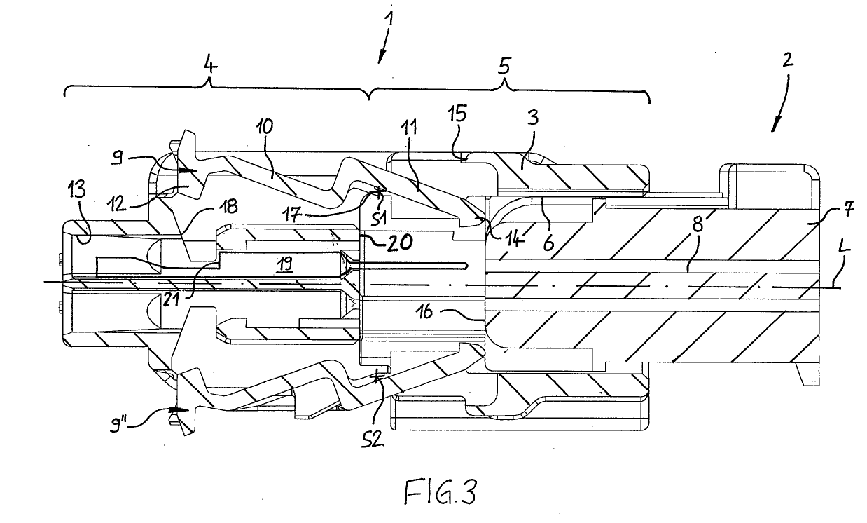

FIG. 3 a longitudinal sectional view through the connector and the mating connector of FIG. 1, wherein the longitudinal sectional view extends through the locking portion of two secondary locking elements,

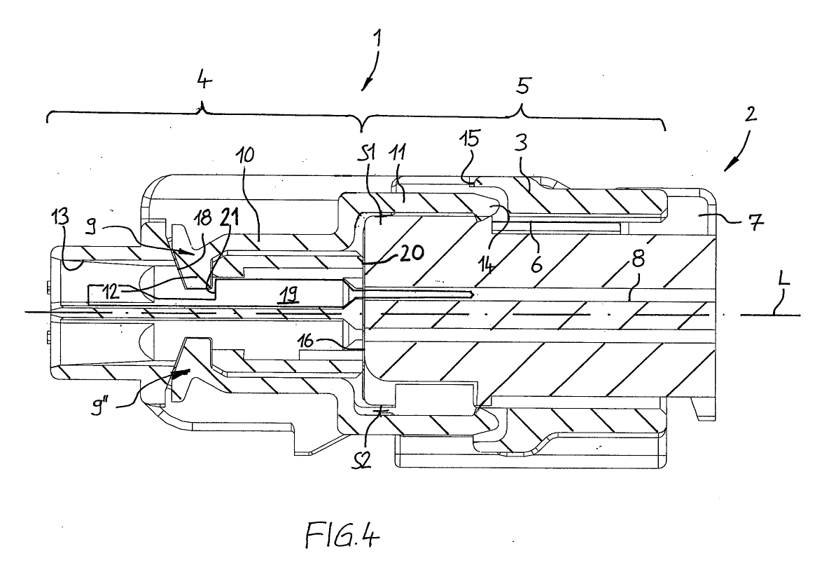

FIG. 4 a longitudinal sectional view according to FIG. 3, wherein the secondary locking elements are in the locking position,

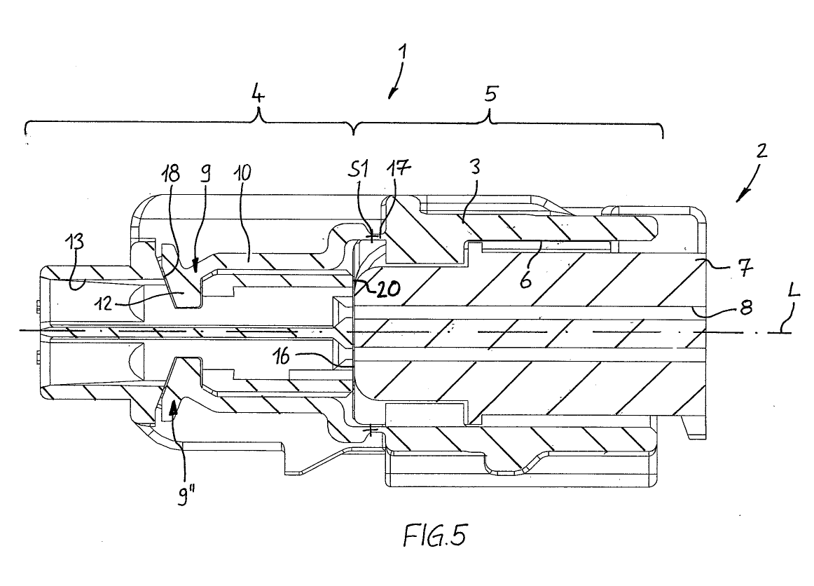

FIG. 5 a longitudinal sectional view through the connector and the mating connector according to FIG. 1, wherein the longitudinal sectional view extends through the film hinge of two secondary locking elements in their unlocking position, and

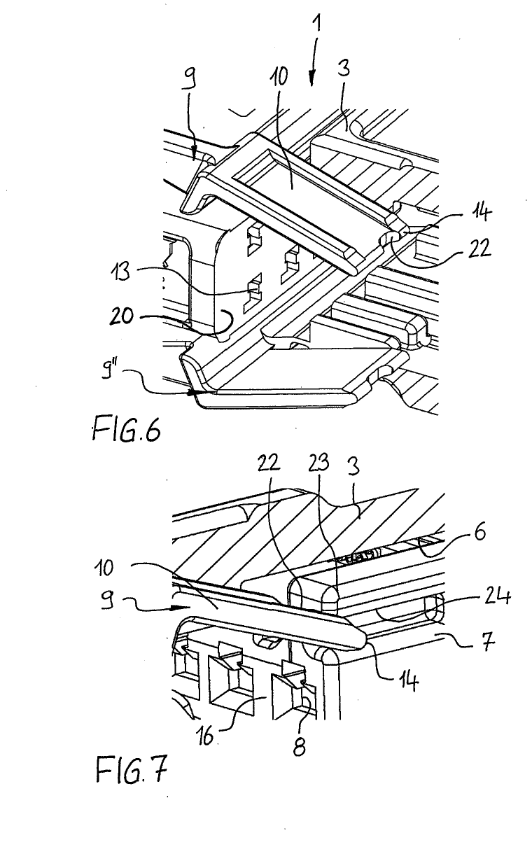

FIG. 6 an enlarged perspective view of the secondary locking and

FIG. 7 an enlarged perspective view of the secondary locking, as this is supported on the mating connector.

FIGS. 1 and 2 show both perspective views of a connector 1 and a mating connector 2 according to the invention and are described in the following together. In this case, FIG. 1 shows the mating connector 2 in a condition, in which it is not completely connected to the connector 1 and FIG. 2 shows a completely connected condition.

The connector 1 comprises a housing 3, which is functionally separated along a longitudinal axis L into a first housing portion 4 and a second housing portion 5. In the first housing portion 4, accommodation chambers 13, arranged parallel to the longitudinal axis L, are located for contact elements not shown here. The first housing portion 4 merges into the second housing portion 5, which forms a receptacle 6 for the mating connector 2. The second housing 5 is formed as a socket, into which a front housing portion of a housing 7 of the mating connector 2 is insertable. The housing 7 of the mating connector 2 has also accommodation chambers 8, arranged parallel to the longitudinal axis L, for contact elements not shown here. The contact elements of the connector 1 are formed as male contact elements and project from their respective accommodation chambers 13 into the receptacle 6. The contact elements of the mating connector 2 are formed as female contact elements, which are arranged within the housing 7 of the mating connector 2. In the not completely connected position of the mating connector 2 shown in FIG. 1, the male contact elements do not contact the female contact elements. In the completely connected position of the mating connector 2 shown in FIG. 2, the male contact elements are connected to the female contact elements, wherein the male contact elements project into the accommodation chambers 8 of the mating connector 2, wherein the accommodation chambers 8 of the mating connector 2 end in openings of an end face 16 of the housing 7.

On the housing 3 of the connector 1, four secondary locking elements 9, 9′, 9″ are arranged, of which three are visible in the perspective view. The secondary locking elements 9, 9′, 9″ are identical and formed mirror-inverted to each other. As their function is identical, this is described in the following by means of one of the secondary locking elements 9.

Two of the secondary locking elements 9, 9′ are pivotably mounted on one side of the housing 3 around a first pivot axis S1. The two other secondary locking elements 9″ are mounted pivotably on a side of the housing 3, facing away, around a second pivot axis S2 on the housing 3. The two pivot axes S1, S2 intersect the longitudinal axis L at a distance and at a right angle thereto.

The secondary locking element 9 is mounted via a film hinge 17 on the housing 3. It has a locking portion 10 and a blocking portion 11, wherein the locking portion 10 is arranged on one side of the first pivot axis S1 and the blocking portion 11 is arranged on the other side of the first pivot axis S1, so that a type of rocker is achieved. The secondary locking element 9 can be pivoted around the first pivot axis S1 between an unlocking position shown in FIG. 1 and a locking position shown in FIG. 2. In the unlocking position, the locking portion 10 is arranged further distanced to the longitudinal axis L than in the locking position. As the locking portion 10 and the blocking portion 11 are formed rocker-like, the blocking portion 11 is arranged in the unlocking position, shown in FIG. 1, closer to the longitudinal axis L than in the locking position shown in FIG. 2.

On the locking portion 10, a locking projection 12, extending parallel to the first pivot axis S1, is provided. The locking projection 12 engages in the locking position several accommodation chambers 13 of the connector 1. For this, a groove 18, arranged parallel to the first pivot axis S1 and which extends into the accommodation chambers 13, is provided in the housing 3 of the connector 1. As later explained, the locking portion 12 engages in the locking position for each accommodation chamber 13 behind a locking face of the respective contact element, so that this cannot be pulled out of the respective accommodation chamber 13.

In the unlocking position, shown in FIG. 1, the locking projection 12 is not arranged within the accommodation chamber 13, so that the secondary locking element 9 does not lock the contact elements. Basically, a primary locking of the contact elements is provided within the accommodation chambers 13, so that these are basically still held in the accommodation chambers 13.

In the unlocking position of the secondary locking element 9 a free end 14 of the blocking portion 11 of the secondary locking element 9 is arranged within the receptacle 6 of the connector 1. For this, a through opening 15, which reaches from the outside into the receptacle 6, is provided in the second housing portion 5 of the housing 3. The blocking portion 11 projects, therefore, in the unlocking portion of the secondary locking element 9 through the through opening 15 into the receptacle 6. The free end 14 is arranged such, that the mating connector 2 abuts with an end face 16 of the housing 7 on the free end 14 of the blocking portion 11, when it is tried to connect the mating connector 2 to the connector 1. Therefore, it is prevented, that the connector 1 can be connected to the mating connector 2, when the secondary locking elements 9, 9′, 9″ are not transferred on the connector 1 into their locking position.

In the unlocking position, shown in FIG. 2, the blocking portions 11 are arranged outside the receptacle 6, so that the housing 7 of the mating connector 2 can be completely inserted with a front portion into the receptacle 6, so that the contact elements are connected.

FIG. 3 shows a longitudinal sectional view of the connector 1 and of the mating connector 2 according to FIGS. 1 and 2, wherein schematically a contact element in form of a male contact element is shown. The locking element 9 is arranged in FIG. 3 in the unlocking position, as well as the locking element 9″. The locking projection 12 is, therefore, arranged outside of the accommodation chamber 13. Furthermore, the free end 14 of the blocking portion 11 is arranged within the receptacle 6, wherein the end face 16 of the housing 7 of the mating connector 2 abuts on the free end 15 and cannot be completely connected. Furthermore, it is visible, that the contact element 19 of the connector 1 cannot enter an accommodation chamber 8 of the mating connector 2, so that no contact is achieved between the contact elements 19 of the connector 1 and the contact elements 19 of the mating connector 2.

FIG. 4 shows the same longitudinal sectional view as FIG. 3, wherein the secondary locking elements 9, 9″ are in their locking position. The locking projection 12 of the secondary locking element 9 is arranged now within the accommodation chamber 13 and engages behind a locking face 21 of the contact element 19, so that a pulling of the contact element 19 out off the accommodation chamber 13 is prevented. The mating connector 2 is arranged completely with a front housing portion in the receptacle 6 of the connector 1. It is visible, that the contact element 19 projects now into an accommodation chamber 8 of the mating connector 2, so that a contact with a contact element of the mating connector 2, not shown here, is ensured.

Furthermore, in the longitudinal sectional view it is visible, that the blocking portion 11 of the secondary locking element 9 projects passed an end face 20 of the housing 3 of the connector 1, wherein the blocking portion 11 projects in the unlocking position of the secondary locking element 9, shown in FIG. 3, further away from the end face 20 than the contact element 19, to ensure, that the contact elements 19 of the connector 1 cannot be brought into contact with those of the mating connector 2.

FIG. 5 shows also a longitudinal sectional view through the connector 1 and the mating connector 2 in the area of the film hinge 17, wherein the secondary locking element 9 is shown in the locking position.

FIG. 6 shows an enlarged view of the secondary locking element according to the invention. It is visible, that on the free end 14 of the blocking portion 11 a notch 22 is provided. As visible in FIG. 7, the mating connector 2 is supported with a wall 23 on the free end 14. The wall has a lateral recess 24 extending parallel to the longitudinal axis L, so that the wall 23 is formed narrower in this area, as e.g. in an area above the free end 14 according to FIG. 7. The free end 14 is supported with the notch 22 on the wall 23, so that the wall 23 engages in the area of the recess 24, i.e. in the area, which is formed thinner, into the notch 22. Thus, also the free end 14 enters with areas laterally of the notch 22 into the recess 24. Thus, it is ensured, that, when trying to insert the mating connector 2 into the receptacle 6, a transferral of the secondary locking elements 9 from the unlocking position, shown in FIG. 7, into the locking position is prevented, as the blocking portions 11 are securely held.

### REFERENCE NUMERALS LIST

1 connector
2 counter connector (mating connector)
3 housing of the connector
4 first housing portion
5 second housing portion
6 receptacle
7 housing of the counter connector
8 accomodation chamber
9 secondary locking element
10 locking portion
11 blocking portion
12 locking projection
13 accomodation chamber
14 free end
15 through opening
16 end face
17 film hinge
18 groove
19 contact element
20 end face
21 locking face
22 notch
23 wall
24 recess
L longitudinal axis
S1 first pivot axis
S2 second pivot axis

1. Connector (1) for connecting to a mating connector (2), comprising
a housing (3), which has a first housing portion (4) with accommodation chambers (13) for contact elements (19) and a second housing portion (5) with a receptacle for a housing portion of the mating connector (2),
at least one secondary locking element (9),
which is mounted pivotably on the housing (3) between an unlocking position and a locking position,
which has a locking portion (10), which projects in the locking position of the secondary locking element (9) at least into one accommodation chamber (13), and
which has a blocking portion (11), which, in the unlocking position, prevents a complete connection of the mating connector (2) to the connector (1) and which, in the locking position of the secondary locking element (9), enables a complete connection.

2. Connector according to claim 1,
characterised in
that the blocking portion (11) is arranged such, that the mating connector (2) abuts, when connecting to the connector (1), with an end face (16) on the blocking portion (11) to prevent a connection of the mating connector (2) to the connector (1).

3. Connector according to claim 1 and 2,
characterised in
that the secondary locking element (9) is attached pivotably between the locking portion (10) and the blocking portion (11) on the housing.

4. Connector according to one of claims 1 to 3,
characterised in
that the secondary locking element (9) is integrally and pivotably connected via a film hinge (17) to the housing (3).

5. Connector according to one of claims 1 to 4,
characterised in
that the blocking portion (11) projects in the unlocking position of the secondary locking element (9) into the receptacle (6) of the housing (3).

6. Connector according to one of claims 1 to 5,
characterised in
that the blocking portion (11) is arranged in the locking position of the secondary locking element (9) outside of the receptacle (6) of the housing (3).

7. Connector according to one of claims 1 to 6,
characterised in
that the first housing portion (4) has an end face (20) limiting the receptacle (6), beyond which the blocking portion (11) projects.

8. Connector according to one of claims 1 to 7,
characterised in
that the accommodation chambers (13) are arranged parallel to a longitudinal axis (L) of the housing.

9. Connector according to one of claims 1 to 8,
characterised in
that the contact elements (19) are insertable, starting from a rear side of the housing (3), respectively into an accommodation chamber (13).

10. Connector according to one of claims 1 to 9,
characterised in
that the contact elements (19) project in a completely inserted final position with a contact portion from the first housing portion (4) into the receptacle (6).

11. Connector according to one of claims 1 to 10,
characterised in
that the locking portion (10) of the at least one secondary locking element (9) has at least one locking projection (12), which, in the locking position, projects into at least one of the accommodation chambers (13) and engages behind a locking face (21) of a completely inserted contact element (19), to prevent a pulling out of the contact element (19), wherein the locking projection (12), in case of one not completely inserted contact element (19), when transferring the secondary locking element (9) from the unlocking position in the direction of the locking position, abuts on a holding portion of the contact element (19) and prevents a transferring of the secondary locking element (9) into the locking position.
